(19) United States
(12) Patent Application Publication
(10) Pub. No.: US 2010/0321743 A1
(43) Pub. Date: Dec. 23, 2010

(54) CODING METHOD, RECORDING METHOD, AND RECORDING APPARATUS

(75) Inventors: Shinichi Miyazaki, Kawasaki-shi (JP); Yoshikazu Ishikawa, Yokohama-shi (JP); Toshiki Miyazaki, Tokyo (JP); Mitsuru Uratani, Kawasaki-shi (JP); Hiroshi Mori, Yokohama-shi (JP); Yumi Yanai, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/814,300

(22) Filed: Jun. 11, 2010

(30) Foreign Application Priority Data
Jun. 19, 2009 (JP) 2009-146931

(51) Int. Cl. H04N 1/04

(52) U.S. Cl. 358/474

(57) ABSTRACT

A method for coding mask data containing information indicating, for each pixel, presence of thinning of image data in order to perform multipass recoding for a predetermined area of a recording medium by N (N: integer of 2 or more) times, includes acquiring a plurality of mask data, assigning a code represented by a number of bits smaller than N based on information contained in the same address of the acquired mask data and use-order of the mask data, and generating coded data containing the assigned code corresponding to an arrangement of the address that the mask data retains information thereof.

### BACKGROUND OF THE INVENTION

1. Field of the Invention

The present invention relates to a mask pattern used in multipass recording, and more specifically to a mask pattern coding method, and a recoding method, and a recoding apparatus using the mask pattern.

2. Description of the Related Art

As an example of an apparatus for performing a recording operation by using a recording head that includes a plurality of recording elements, there is conventionally known an ink jet recording apparatus that uses a recording head including a plurality of ink discharge ports.

Among others, in an ink jet recording apparatus of a serial type, an image is formed by intermittently repeating recording main-scanning for scanning a recording head which discharges ink at a predetermined frequency at a speed corresponding to the frequency, and a conveying operation for conveying a recording medium in a direction intersecting that of the recording main-scanning. The ink jet recording apparatus of the serial type can be manufactured relatively compact at low cost, and hence widespread for personal use.

As one recording method for improving recording quality in such a recording apparatus, there is known a multipass recording method. According to this method, for a line as a pixel row in which a ink dot is formed on a recording medium corresponding to each ink discharge port by scanning of a recording head, a plurality of scanning times of the recording head (hereinafter, scanning is referred to as pass) and conveying of a recording sheet as a recording medium between passes are repeated, thereby associating a plurality of different discharge ports with the same line, and the same line is recorded by inks discharged from the different discharge ports.

By this multipass recording method, even when a discharge amount or a discharge direction varies from one discharge port to another of the recording head, each line constituting an image to be recorded is formed by inks discharger from the plurality of different discharge ports, and hence the variance among the discharge ports is dispersed. As a result, occurrence of density nonuniformity such as white streaks or black streaks caused by the variance can be suppressed.

Japanese Patent Application Laid-Open No. 02-231149 discusses an exemplary multipass recording method. This multipass recording method records an image by discharging inks of identical colors from a plurality of different nozzles to the same pixel.

When multipass recording is performed, its data to be recorded is generally generated by using mask data (mask). As described above, each line relating to recording is completed by a plurality of passes of the recording head. In each line, a pixel to be recorded by each of the plurality of passes and a pixel to be recorded by another pass are accordingly in a mutually complementary relationship to each other. Thus, a mask data is used for determining a pixel to be recorded by each of the plurality of passes.

For the mask data, there are various patterns with data arrangement of 1 and 0 regarding pixels. For example, Japanese Patent Application Laid-Open No. 07-052390 discusses a pattern that uses a random number for mask data. Japanese Patent Laid-Open No. 06-143618 discusses mask data that lowers, in order to reduce a boundary streak as a kind of density nonuniformity generated on a boundary of pass areas, a recording ratio of a pixel adjacent to the boundary.

For the abovementioned mask data, in order to perform mask processing for the data to be recorded (binary data) in the recording apparatus, a configuration of storing a mask data in the recording apparatus beforehand may be employed. The mask data must contain individual masks corresponding to the plurality of passes. As the number of modes or nozzles of multipass recording is larger, more data must be stored in a memory (e.g., read-only memory: ROM) so as to prepare more mask data. In consequence, since a memory capacity of the ROM needs to be increased, it is difficult to achieve lower cost.

In order to solve the above-mentioned problem, Japanese Patent Application Laid-Open No. 08-183208 discusses a technique which rasterizes image data to a bitmap to store the data in a rasterization buffer, and records a mask of the bitmap in the rasterization buffer by AND processing for each recording pass. Data having 1 and 0 of the mask data reversed is subjected to AND processing to be updated on the bitmap. This configuration enables the number of masks to be prepared to be smaller by one than the number of passes.

This technique is advantageous in that a memory capacity for storing mask data is smaller. Thus, for example, a capacity can be reduced by ½ (50% reduction) in the case of mask data of 2 passes. In the case of mask data of 16 passes, however, a capacity is reduced by 15/16 (6.25% reduction). As the number of passes is larger, a capacity reduction rate of mask data is smaller.

Conventionally, there has been a desire to reduce a storage capacity of mask data used when an image is recorded by a plurality of passes. However, when a mask data is simply compressed for each pass by a predetermined compression method, a compression rate depends on a mask pattern of each pass, and hence the storage capacity cannot always be reduced efficiently.

### SUMMARY OF THE INVENTION

According to an aspect of the present invention, a method for coding mask data containing information indicating, for each pixel, presence of thinning of image data in order to perform multipass recoding for a predetermined area of a recording medium by N (N: integer of 2 or more) times, includes acquiring a plurality of mask data, assigning a code represented by a number of bits smaller than N based on information contained in the same address of the acquired mask data and use-order of the mask data, and generating coded data containing the assigned code corresponding to an arrangement of the address that the mask data retains information thereof.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a mask data (mask) according to the present invention.

FIG. 2 illustrates an internal configuration of an ink jet recording apparatus of a serial type according to an exemplary embodiment of the present invention.

FIG. 3 is a block diagram schematically illustrating a configuration of control hardware of the ink jet recording apparatus according to an exemplary embodiment of the present invention.

FIG. 4 illustrates a relationship between mask data and image data in 4-pass recording according to a first exemplary embodiment of the present invention.

FIG. 5 is a flowchart illustrating coding processing of mask data according to the first exemplary embodiment.

FIG. 6 illustrates a relationship between generated coded data and mask data according to the first exemplary embodiment.

FIG. 7 illustrates a data format having attribute information added thereto according to the first exemplary embodiment.

FIG. 8 is a flowchart illustrating decoding processing to mask data according to the first exemplary embodiment.

FIG. 9 illustrates a relationship between mask data and image data in 4-pass recording according to a second exemplary embodiment of the present invention.

FIG. 10 is a flowchart illustrating coding processing of mask data according to the second exemplary embodiment.

FIGS. 11A and 11B illustrate recording pattern information in detail according to the second exemplary embodiment.

FIG. 12 illustrates a relationship between generated coded data and mask data according to the second exemplary embodiment.

FIG. 13 illustrates a data format having attribute information added thereto according to the second exemplary embodiment.

FIG. 14 is a flowchart illustrating decoding processing to mask data according to the second exemplary embodiment.

FIG. 15 is a block diagram illustrating a computer for executing the processing illustrated in FIG. 5 or FIG. 10.

### DESCRIPTION OF THE EMBODIMENTS

Various exemplary embodiments, features, and aspects of the invention will be described in detail below with reference to the drawings.

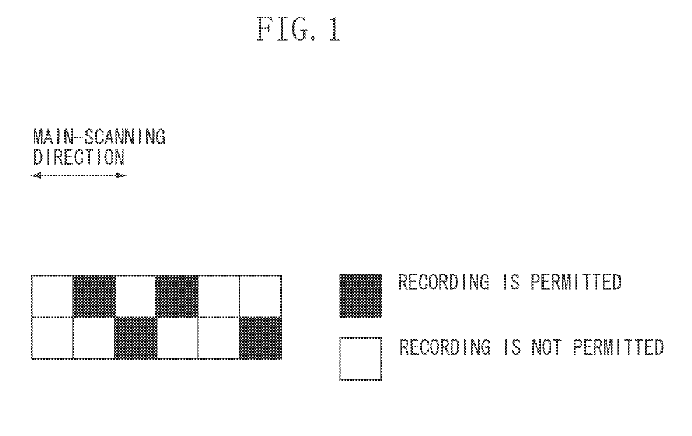

Referring to FIG. 1, mask data used in a first exemplary embodiment will be described.

As illustrated in FIG. 1, a size of mask data is 6 pixels in a main-scanning direction and 2 pixels in a sub-scanning direction (6 pixels×2 pixels). The mask data contains information designating “a pixel in which recording is permitted” and “a pixel in which recording is not permitted” for each pixel. In other words, the mask data contains information designating “a pixel in which thinning is not executed” and “a pixel in which thinning is executed” for each pixel.

In FIG. 1, a black section indicates “a pixel in which recording is permitted” or “a pixel in which thinning is not executed”. A white section indicates “a pixel in which recording is not permitted” or “a pixel in which thinning is executed”. Which pass is used to perform recording is determined by executing AND calculation of the information of the mask data and recorded data (binary data). The mask data may also be referred to as a mask pattern.

In many cases, a larger size is used for an actual mask of the recording apparatus as illustrated in FIG. 1. In the present exemplary embodiment, however, a mask of a small size is used for simpler description.

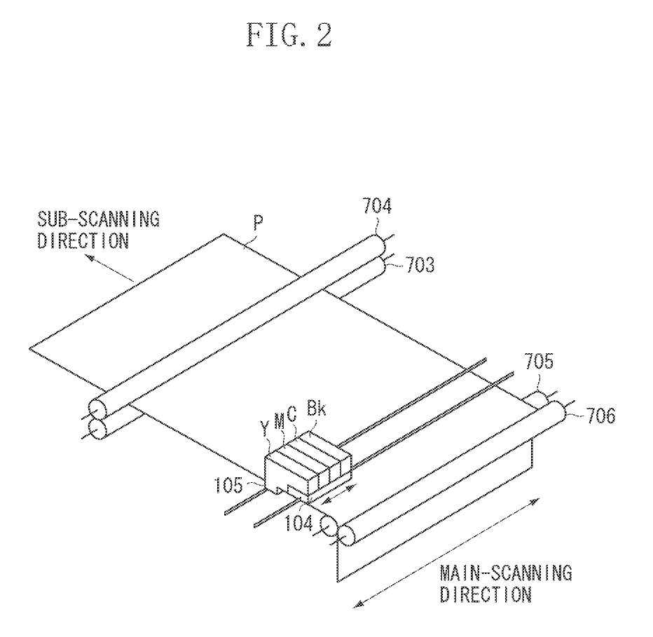

FIG. 2 schematically illustrates an internal configuration of an ink jet recording apparatus of a serial type used in the present exemplary embodiment. A recording head 105 is mounted on a carriage 104, which moves in a main-scanning direction at a fixed speed, and discharges ink droplets at a frequency corresponding to the fixed speed.

After completion of one scanning recording operation, a conveyance roller 704 and an auxiliary roller 703 rotate. A recording medium P held between this roller pair, and a feeding roller 705 and an auxiliary roller 706 is conveyed in a sub-scanning direction by an amount corresponding to a recording width of the recording head 105. By intermittently repeating such recording in a main-scanning direction and a conveying operation, an image is recorded on the recording medium P in stages.

The recording head 105 includes recording heads of black (Bk), cyan (C), magenta (M), and yellow (Y) arrayed in parallel in the main-scanning direction as illustrated in FIG. 2. The recording head of each color includes a plurality of recording elements arrayed in a sub-scanning direction at equal densities according to recording resolution.

The recording head may be allowed to use, in addition to the above four colors, one or all of mat black (MBk), gray (Gy), light gray (Lg), light cyan (Lc), light magenta (Lm), red (R), green (G), and blue (B).

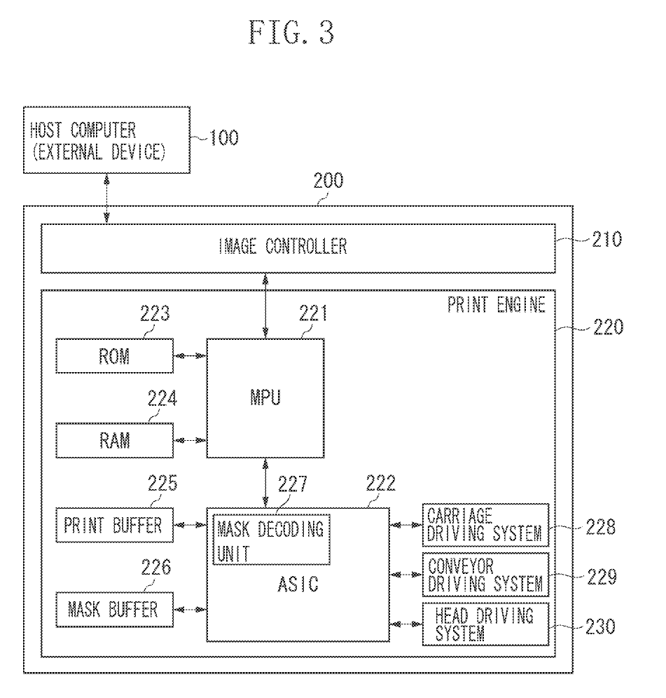

FIG. 3 schematically illustrates a configuration of control hardware of a recording apparatus 200.

The recording apparatus 200 includes an image controller 210 and a print engine 220. The recording apparatus 200 receives image data from a host computer (external device) (hereinafter, simply referred to as a host) 100 to perform recording. The image controller 210 notifies the print engine 220 of a control command according to a command from an operation unit (not illustrated) of the recording apparatus 200 or the host computer 100. Separately, during recording, the image controller 210 analyzes and rasterizes recorded data received from the host computer 100, and converts the recorded data into binary image data of each color.

The operation unit includes an input unit including various input keys on an operation panel of the recording apparatus 200, and a display unit including a liquid crystal display. The print engine 220 performs an actual recording operation based on the control command and the image data transmitted from the image controller 210.

The image controller 210 and the print engine 220 are connected to each other via a dedicated interface. The image controller 210 can perform command communication to notify the print engine 220 of the control command. The print engine 220 can perform communication including status transmission to notify the image controller 210 of a status change of the print engine 220 via the interface. The image controller 210 can transfer the image data to the print engine 220.

The print engine 220 itself is controlled by a microprocessor unit (MPU) 221 according to a program recorded in a ROM 223. A random access memory (RAM) 224 is used as a work area or a temporary data storage area of the MPU 221.

The MPU 221 controls, via an application specific integrated circuit (ASIC) 222, a carriage driving system 228, a conveyor driving system 229, and a head driving system 230. The MPU 221 can read/write data in a readable/writable print buffer 225 or mask buffer 226 from the ASIC 222. The ASIC 222 includes a mask decoding unit 227 for decoding coded mask data.

The print buffer 225 temporarily stores image data converted into a format that can be transmitted to the head. The image data converted into the format that can be transferred to the head is data having the number of pixels equal to the number of nozzles in a long direction (sub-scanning direction of FIG. 1) of the head, which may be referred to as nozzle data hereinafter).

The mask buffer 226 temporarily stores a predetermined mask pattern for performing AND processing (mask by a logical product) for the image data transferred to the head from the print buffer 225. By repeating AND processing for the mask data and the image data to be transferred to the head, thinning for multipass recording is realized.

A plurality of sets of mask data for multipass recording different in number of passes is prepared in a coded status in the ROM 223. During actual recording, relevant coded mask data is read from the ROM 223, and decoded by the mask decoding unit 227 of the ASIC 222. The decoded mask data is stored in the mask buffer 226.

Next, referring to FIG. 3, a recording operation of the recording apparatus 200 will roughly be described.

Recording processing is started when the host computer 100 transits image data to the recording apparatus 200. The image controller 210 analyzes the image data and a print command received from the host computer 100, and generates information such as recording quality necessary for recording. The image controller 210 further analyzes the image data, and rasterizes the image data to convert it into binary image data of each color.

The image controller 210 determines the number of recording passes, and notifies the MPU 221 of the number of recording passes. The MPU 221 reads, from the ROM 223, a compressed mask relating to the number of passes notified of from the image controller 210, decodes the mask by the mask decoding unit 227, and writes the decoded mask data in the mask buffer 226.

Then, the image controller 210 transfers the binary image data of each color obtained by converting the image data to the print engine 220. The print engine 220 converts the transferred image data into nozzle data, and writes the nozzle data in the print buffer 225.

Image transfer from the image controller 210 is repeated, and the print engine 220 accordingly stores nozzle data one after another in the print buffer 225. When the storage of nozzle data in the print buffer 225 reaches an amount enabling recording of band data during one scanning operation of the recording head 105, the MPU 221 conveys, via the ASIC 222, a sheet by using the conveyor driving system 229, and moves the carriage by using the carriage driving system 228. The MPU 221 sets an image output position in the ASIC 222, and drives the carriage to start recording.

When the carriage moves and reaches the recording start portion set in the ASIC 222, the nozzle data are sequentially read from the print buffer 225. Simultaneously, corresponding mask data are read from the mask buffer 226. The nozzle data and the mask data that have been read are subjected to AND (logical AND processing) to be transferred to the head.

Under control of the head driving system 230, the recording head drives the nozzles to perform discharging according to the transferred data. The MPU 221 performs recording processing by repeating image reception from the image controller 210 to processing of this stage.

Hereinafter, coding processing and decoding processing of the mask data according to the first exemplary embodiment are described in detail.

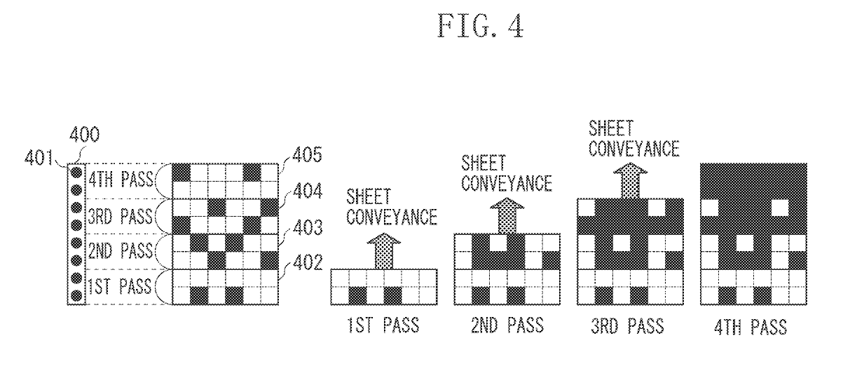

FIG. 4 illustrates a relationship between mask data and image data of 4 passes according to the first exemplary embodiment. The mask data is prepared for each pass. In the first exemplary embodiment, the number of passes is 4, and hence the recording apparatus has 4 mask data. Mask data 402 is used at a 1st pass, mask data 403 is used at a 2nd pass, mask data 404 is used at a 3rd pass, and mask data 405 is used at a 4th pass.

As illustrated in FIG. 4, a plurality (8) of nozzles provided in a head 400 are divided into 4 groups, and mask data is assigned for each group. In other words, a nozzle area of the head 400 is divided, and mask data are assigned to the divided areas. For easier understanding, in the first exemplary embodiment, the arrangement is described based on the mask data of the format illustrated in FIG. 1. In the first exemplary embodiment, mask data of each pass is defined so as to inhibit thinning of all pixels in one pass area when pixels of identical positions are subjected to logical OR processing for 4 masks (402 to 405).

In FIG. 4, the head 400 includes 8 nozzles 401. For this nozzle array, a sheet is conveyed from the bottom side in the FIG. 4 by every 2 nozzles. A mask and image data are subjected to AND (logical AND processing), thereby acquiring output data to be recorded at each pass. Thus, as illustrated in FIG. 4, a dot position of recording at each pass is equal to data acquired by performing OR (logical OR processing) for each mask up to the pass, and a dot output result after the end of recording at the 4th pass is image data itself, completing an image.

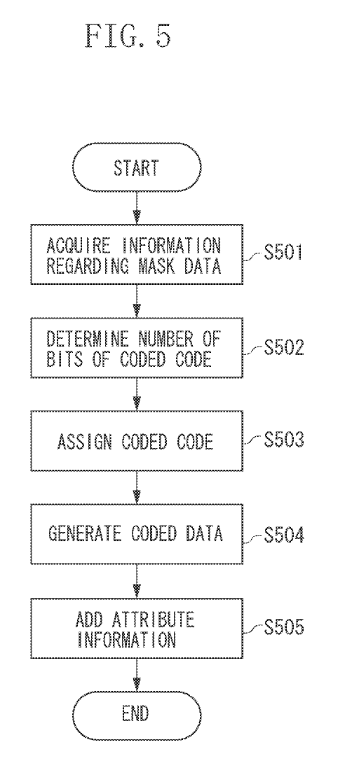

Referring to a flowchart illustrated in FIG. 5, the mask data coding processing of the present exemplary embodiment will be described more in detail. This processing is performed beforehand by a manufacturer. The manufacturer stores coded mask data acquired as a result of the processing in the ROM 223 of the recording apparatus to sell the apparatus. In order to add mask data after the selling of the product, the recording apparatus performs processing of adding coded data acquired in the processing of FIG. 5 or processing of changing mask data based on the coded date acquired in the processing of FIG. 5.

The mask data to be added or changed is supplied from the host computer 100. However, a memory card may be loaded in a memory card unit (not illustrated), and such mask data may be read from the memory card. When acquiring mask data, the host computer 100 may load the memory card to acquire the mask data, or downloads the mask data via a network. A similar supplying method of mask data to be added or updated is employed in other exemplary embodiments.

Referring to FIG. 5, the mask data coding processing illustrated in FIG. 4 will be described in detail.

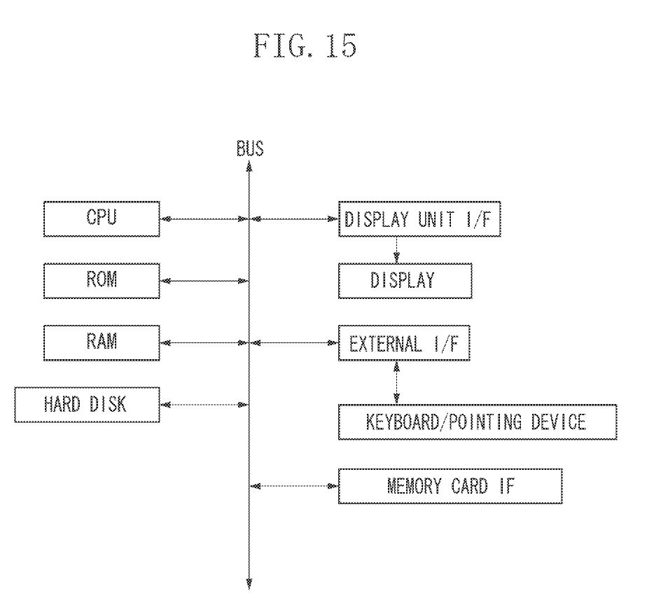

FIG. 5 is a flowchart illustrating processing performed by a computer (FIG. 15) during manufacturing of the recording apparatus 200. The processing performed in FIG. 5 is installed as a computer-executable program in the computer illustrated in FIG. 15, stored in a storage unit such as a RAM or a hard disk of the computer, and read to be executed by a CPU of the computer.

In FIG. 5, in step S501, the CPU of the computer first acquires information regarding mask data. The information regarding the mask data is the number of recording patterns obtained by analyzing the number of passes and mask data. The number of recording patterns is information regarding a total number of recording patterns indicating which pass is used to record an output pixel.

For the mask data used according to the first exemplary embodiment, all pixels of a mask area are recorded based on a recording pattern of one selected from “recording at 1st pass”, “recording at 2nd pass”, “recording at 3rd pass”, and “recording at 4th pass”. Thus, “4” is acquired as the number of passes, and “4” is acquired as the number of recording patterns.

In step S502, the CPU determines the number of bits for a code. In the first exemplary embodiment, the minimum number of bits indicating the number of recording patterns is set as the number of bits for a code. This code is represented by a binary digit. The number of recording patterns acquired in step S501 is “4”, and hence 2 bits are identified as the minimum number of bits capable of representing 4 pieces of information.

In step S503, the CPU assigns the code represented by the number of bits identified in step S502 to each recording pattern. In the first exemplary embodiment, the CPU assigns “11” to the “recoding at 1st pass”, “10” to the “recording at 2nd pass”, “01” to the “recording at 3rd pass”, and “00” to the “recording at 4th pass”. In step S504, the CPU generates coded data (index data) based on the above information.

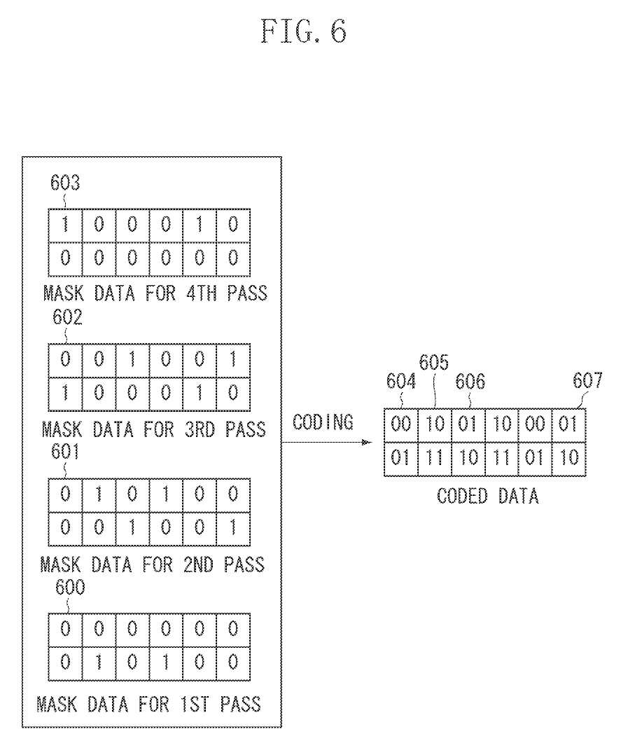

FIG. 6 illustrates the mask data illustrated in FIG. 4 and coded data (index data) 607. The coded data 607 is coded according to a rule described below. The mask data in FIG. 6 is illustrated as binary data where a pixel of recoding is “1” and a pixel of no recording is “0”. FIG. 6 illustrates pixels 600 to 603 of identical positions of respective masks. The pixel positions 600 to 603 are all pixel positions for performing AND (logical AND) processing for pixel values of pixels located in the identical pixel positions of image data and values of the masks.

In FIG. 6, for example, the pixel positions 600 to 603 on the left upper side of the mask data respectively indicate a pixel position of 1st pass mask data, a pixel position of 2nd pass mask data, a pixel position of 3rd pass mask data, and a pixel position of 4th pass mask data. A pixel position 604 of the coded data 607 in FIG. 6 indicates a position corresponding to the pixel positions 600 to 603 of the 1st to 4th pass mask data.

In the first exemplary embodiment, a value of the pixel position 603 of the 4th pass mask data is “1”, and values of the pixel position 600 (1st pass), the pixel position 601 (2nd pass), and the pixel position 602 (3rd pass) are “0”. Thus, when a value of image data corresponding to the pixel positions 601 to 603 is “1”, the image data is not recorded at the 1st to 3rd passes, but the data is recorded at the 4th pass.

Thus, based on values stored in the identical pixel positions of the mask data and use order of the mask data, the CPU assigns codes thereto. In the pixel position 604 of the coded data 607, the CPU sets the code “00” assigned to the “recording at 4th pass” in step S503 as data. Similarly, the CPU sets a code “10” in a pixel position 605 because it is recoded at the 2nd pass, and a code “01” in a pixel position 606 because it is recorded at the 3rd pass.

The CPU determines a code for each pixel position as described above, and arranges an address for the code as in the case of the mask data to generate coded data 607. In step S505, the CPU adds attribute information necessary for decoding the coded data 607 to the coded data 607.

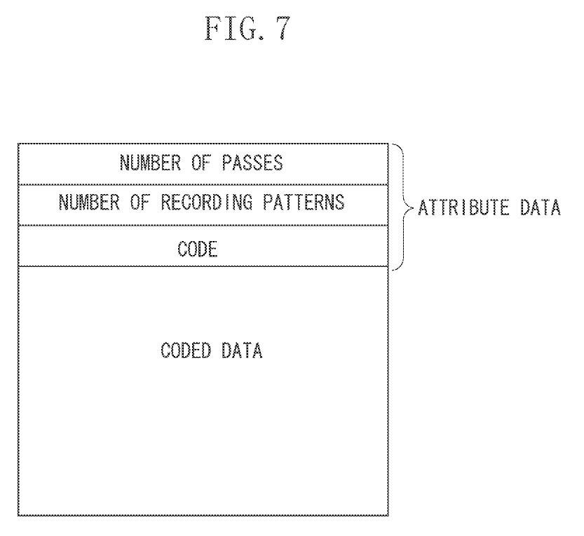

FIG. 7 illustrates a format of the coded data to which the attribute data has been added. As attribute information, the number of passes, the number of recording patterns, and an assigned code are included. The ROM 223 stores information (information on assigning rule of pass and code) for decoding a code to mask data beforehand. By using this information, mask data of each pass is generated.

This rule information is commonly used when there is a plurality of kinds of coded data. By using the rule in common, for example, when the recording apparatus executes a plurality of recording modes of 4 passes, an increase in use of the ROM 223 can be suppressed. The coded data to which the attribute information has been added is given a predetermined file name, and output to the storage unit of the computer illustrated in FIG. 15, which has executed the program. When the number of passes and the number of recording patterns are equal, the information of the number of recording patterns may be omitted.

By the coding method according to the first exemplary embodiment, for example, a capacity of coded data when mask data (mask of each pass has 10 pixels×10 pixels) of 10 pixels×40 pixels is coded is totally 212 bits where attribute information is 12 bits (2 bits (number of passes: describable up to 4 passes)+2 bits (number of recording patterns)+8 bits (total number of bits of code corresponding to each recording pattern), and coded data is 200 bits (2 bits×100 pixels).

On the other hand, the capacity of the conventional mask data 400 is 400 bits (1 bit×100 pixels×4 passes). More specifically, the number of recording patterns can be represented by the number of passes. When the number of bits for a code is small, a storage capacity of mask data can be reduced.

Thus, the coding method of the first exemplary embodiment enables reduction of the storage capacity of mask data. When a mask size is increased or the number of passes is increased, the storage capacity of the mask data can be reduced more.

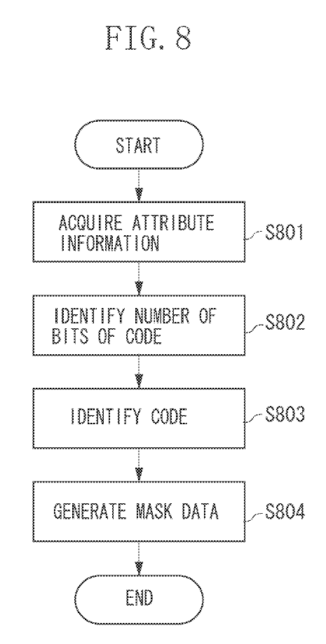

Next, referring to a flowchart illustrated in FIG. 8, the decoding processing of the mask data will be described more in detail. This processing is performed by the MPU 221 of the recording apparatus 200. In the first exemplary embodiment, the processing is described in detail on the assumption that the data where the attribute data has been added to the coded data of FIG. 6 is decoded.

First, in step S801, the MPU 221 acquires attribute information. As illustrated in FIG. 7, the attribute information contains the number of passes “4”, the number of recording patterns “4”, and a code. In step S802, the MPU 221 identifies the number of bits for the code. The number of recording patterns acquired in step S801 is “4”, and hence 2 bits are identified as the number of bits, which is a minimum number of bits capable of representing 4 pieces of information. If information on the number of bits for the code has been acquired beforehand, execution of step S802 is omitted.

In step S803, the MPU 221 identifies codes respectively assigned corresponding to the recording patterns. More specifically, the MPU 211 identifies all codes used for the coded data. Based on the number of recording patterns and the code acquired in previous steps, the codes assigned to the recording patterns are identified as follows: “recording at 1st pass” is “11 (binary digit)”, “recording at 2nd pass” is “10 (binary digit)”, “recording at 3rd pass” is “01 (binary digit)”, and “recording at 4th pass” is “00 (binary digit)”.

In step S804, the MPU 221 generates mask data from the coded data by using the number of passes acquired in step S801, the number of bits for the code identified in step S802, and the codes assigned to the recording patterns that is identified in step S803. This generation processing is performed based on rules stored in the ROM 223. As in the case of the aforementioned coding processing, the processing will be described in detail referring to FIG. 6.

The number of bits for the code has been identified to be 2 bits in step S802, and hence a pixel position 604 (2 bits) can be identified from the coded data 607 in FIG. 6. A code of the pixel position 604 is “00 (binary digit)”, and the assigning of “00” to the “recording at 4th pass” has been identified. Thus, “1” is set as data in the pixel position 603 of the 4th pass mask, and “0” is set as data in the pixel positions 600 to 602 of the 1st to 3rd pass masks. By sequentially performing processing for the remaining pixel positions (605 and 606) of the coded data 607 through a similar procedure, mask data illustrated in FIG. 6 is generated.

According to the first exemplary embodiment, by storing the data generated for the plurality of sets of mask data via the above coding processing in the ROM 223 in FIG. 3, a memory capacity necessary for storing the mask data can be greatly reduced. Before recording, the data is read from the ROM 223, and decoded by the decoding unit 227 of the ASIC, which includes the decoding processing program to be usable as mask data.

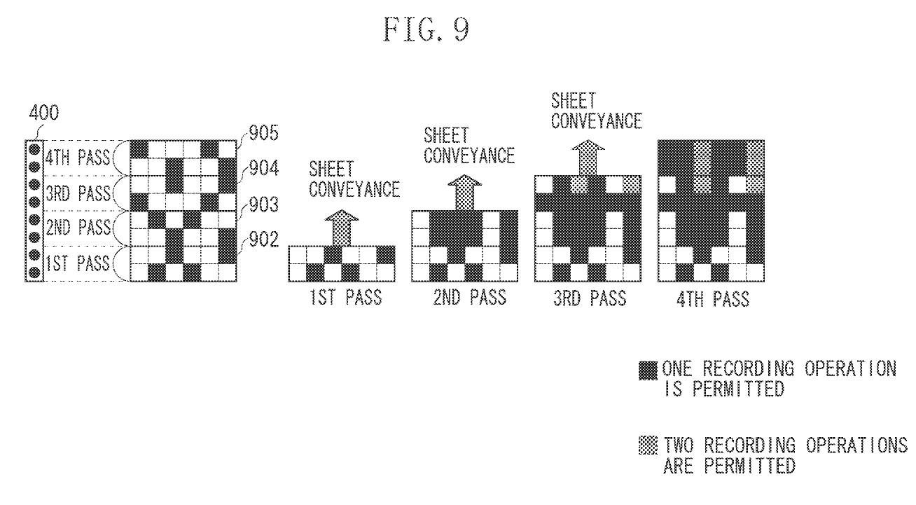

In a second exemplary embodiment, compression/decompression of coded data is described. When the coded data is compressed, codes are assigned so as to increase a data compression rate. FIG. 9 illustrates mask data used for describing coding processing and decoding processing according to the second exemplary embodiment.

A difference of the mask data illustrated in FIG. 9 from the mask data illustrated in FIG. 4 is pixel positions dotted twice when images are generated at 4 passes as illustrated in FIG. 9. Thus, similar pixel positions are blackened by 2 pixels between a mask data 902 and a mask data 904, and 2 pixels between a mask data 903 and a mask data 904 in FIG. 9.

In the mask illustrated in FIG. 4, the mask data of each pass is configured so that all the pixels in the mask area can be recorded by one of the passes. In the mask illustrated in FIG. 9, additionally, for 4 pixels in a mask area, mask data of each pass is configured so as to permit recording of each pixel twice.

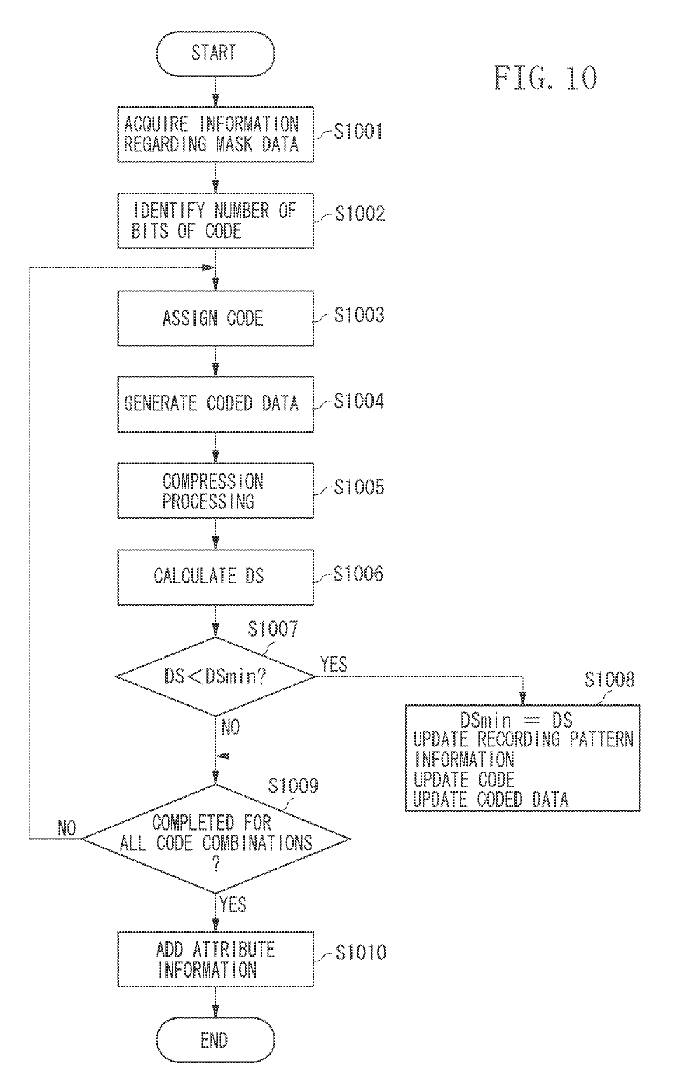

Referring to FIG. 10, the mask data coding processing of the second exemplary embodiment will be described more in detail. The processing of the flowchart illustrated in FIG. 10 is installed as a computer-executable program in the computer in FIG. 15, stored in the RAM or the hard disk of the computer in FIG. 15, and read to be executed by the CPU. This processing is performed during manufacturing of a recording apparatus 200 by a manufacturer.

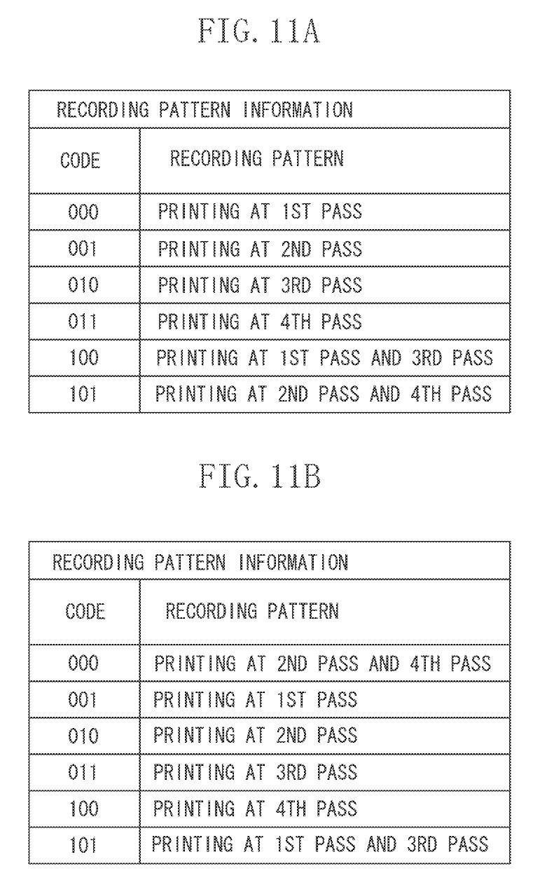

First, in step S1001, the CPU of the computer first acquires information regarding mask data. In the second exemplary embodiment, the information regarding the mask data is the number of recording patterns obtained by analyzing the number of passes and mask data, and recoding pattern information. The recording pattern information is information regarding that which pass is used to record an output pixel (recording pattern). FIGS. 11A and 11B illustrate the recording pattern information in detail. The recording pattern information is added as attribute information in step S1010 described below so as to identify which recording pattern a code assigned during mask data decoding in step S1003 corresponds to.

For the mask data used in the second exemplary embodiment, information of “recording at 1st pass”, “recording at 2nd pass”, “recording at 3rd pass”, “recording at 4th pass”, “recording at 1st pass and 3rd pass”, and “recording at 2nd pass and 4th pass” is acquired as recording patterns as illustrated in FIG. 9. All output pixels corresponding to a mask are recorded based on one of these recording patterns. Thus, “4” is acquired as the number of passes, and “6” is acquired as the number of recording patterns.

In step S1002, the CPU determines the number of bits for a code. As in the case of the first exemplary embodiment, in the second exemplary embodiment, the minimum number of bits indicating the number of recording patterns is set as the number of bits for a code. The recording pattern information acquired in step S1001 is “6”, and hence 3 bits are identified as the minimum number of bits capable of representing 6 pieces of information. In step S1003, the CPU assigns the code represented by the number of bits identified in step S1002 to each recording pattern.

In the second exemplary embodiment, the CPU assigns “000 (binary digit)” to the “recoding at 1st pass”, “001 (binary digit)” to the “recording at 2nd pass”, “010 (binary digit)” to the “recording at 3rd pass”, “011 (binary digit)” to the “recording at 4th pass”, “100 (binary digit)” to the “recording at 1st pass and 3rd pass”, and “101 (binary digit)” to the “recording at 2nd pass and 4th pass”. In step S1004, the CPU generates coded data based on the above information.

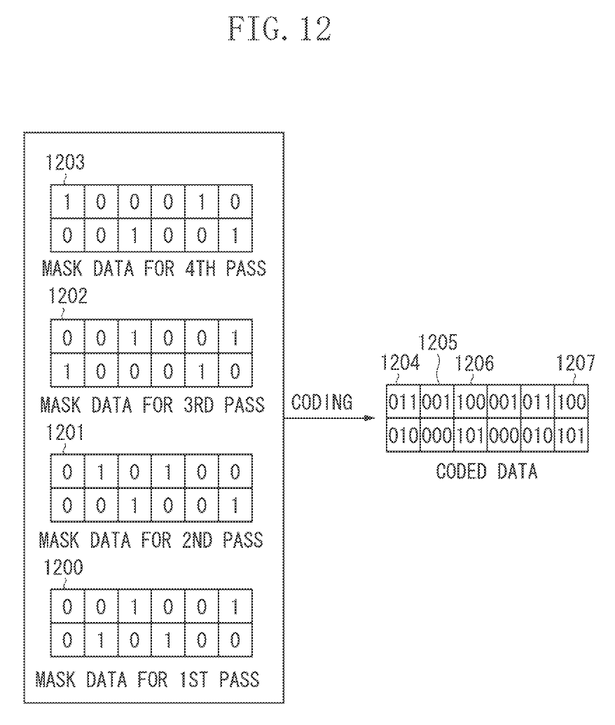

FIG. 12 illustrates the mask data illustrated in FIG. 9 and coded data 1107. As in the case of FIG. 6, in the mask data illustrated in FIG. 12, a value of a poison permitting recoding is “1” and a value of a position not permitting recording is “0”.

Pixel positions 1200 to 1203 in FIG. 12 are similar to those in FIG. 6, and thus description is omitted. The pixel positions 1200 to 1203 are all pixel positions for performing AND (logical AND) processing with pixel values of the identical pixel positions of image data. More specifically, the pixel positions 1200 to 1203 of the identical pixel positions respectively indicate a pixel position of a 1st pass mask data, a pixel position of a 2nd pass mask data, a pixel position of a 3rd pass mask data, and a pixel position of a 4th pass mask data.

In FIG. 12, these pixel positions 1200 to 1203 of the respective masks are located on the left upper sides of the masks. A pixel position 1204 of the coded data 1207 in FIG. 12 corresponds to the pixel positions 1200 to 1203 of the 1st to 4th pass masks. In the second exemplary embodiment, a value of only the pixel position 1203 of the 4th pass mask data is “1”. Thus, even when a pixel value of image data corresponding to the pixel positions 1200 to 1203 is “1” (recorded), no recording is performed at the 1st to 3rd passes, but recording performed only at the 4th pass.

In order to perform such thinning, in the pixel position 1204 of the coded data 1207, the CPU sets the code “011 (binary digit)” assigned to the “recording at 4th pass” in step S1003 as data. Similarly, the CPU sets a code “001 (binary digit)” in a pixel position 1205 because of recoding at the 2nd pass.

The CPU sets a code “100 (binary digit)” in a pixel position 1206 because of recording at the 1st pass and the 3rd pass. Thus, the CPU determines a code to be assigned based on data of each pixel position corresponding to each mask (pixel position of each mask corresponding to a pixel on image data), and generates coded data 1207.

In step S1005, the CPU performs compression processing for the generated coded data. In the second exemplary embodiment, the CPU compresses the coded data generated in step S1004 by a JBIG coding method, which is lossless coding. The JBIG coding method has a function of learning two-dimensional characteristics of bitmap data, which is a compression target. In the second exemplary embodiment, the CPU regards the coded data 1207 generated in step S1004 illustrated in FIG. 12 as binary bitmap data, and generates compressed data by the JBIG coding method.

In step S1006, the CPU calculates a data size (DS) of the compressed data generated in step S1005. In step S1007, the CPU compares the calculated data size (DS) with a minimum data size (DSmin). In this case, as an initial value of the minimum data size (DSmin), a data size of the coded data first generated in step S1004 has been inserted.

If the data size (DS) is smaller than the minimum data size (YES in step S1007), the processing proceeds to step S1008. In step S1008, the CPU updates the data size (DS) as a minimum data size (DSmin), and updates the recording pattern information corresponding to the information of the code assigned in step S1003 and the coded data generated in step S1005. For initial values of the code and the recording pattern information in step S1008, the recording pattern information corresponding to the code first assigned in step S1003 is set. For an initial value of the coded data, the coded data generated from the code first assigned in step S1004 has been inserted.

After step S1008 or “NO” determination in step S1007, in step S1009, the CPU determines whether processing has been completed for all code combinations. If the data size (DS) is equal to or more than the minimum data size (NO in step S1007), without performing update processing of step S1008, in step S1009, the CPU determines whether processing has been competed for all code and recording pattern combinations. The processing of step S1009 will be described below.

As illustrated in FIGS. 11A and 11B, compressed data of a minimum data size can be obtained by changing combinations of the codes and the recording patterns, and executing steps S1003 to S1008. Thus, the combinations of the codes and the recording patterns are changed and, in step S1009, whether the processing of steps S1003 to S1008 has been executed for all the combinations is determined.

If processing is not completed for all the combinations of the codes (3 bits) with respect to the recording patterns (NO in step S1009), the processing returns to step S1003. The CPU changes the codes assigned to the recording patterns, and performs processing up to step S1009. In the second exemplary embodiment, a data amount of compressed data is minimum in the case of FIG. 11A.

If processing has been completed for all the combinations of the codes (3 bits) with respect to the recording patterns (YES in step S1009), in step S1010, the CPU adds attribute information necessary for decoding the compressed data stored in step S1008. The compressed data having the attribute information added thereto in step S1010 is given a predetermined file name, and output to the storage unit such as the RAM or the hard disk of the computer in FIG. 15, which has executed the processing of the flowchart illustrated in FIG. 10.

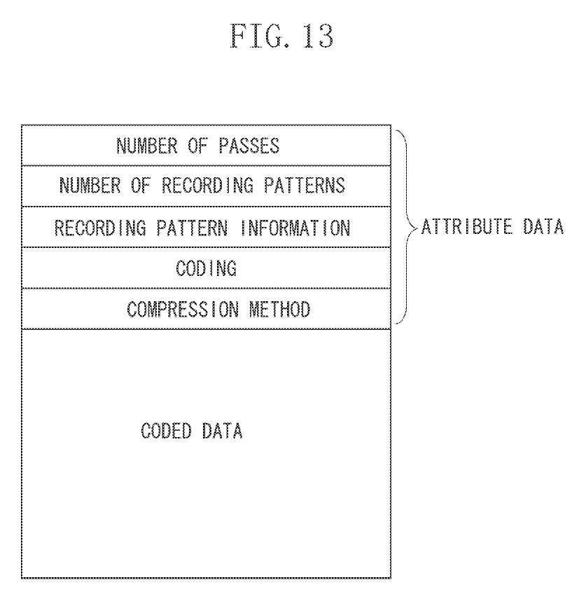

FIG. 13 illustrates a format of the coded data to which the attribute data has been added according to the second exemplary embodiment. As illustrated in FIG. 13, in the second exemplary embodiment, as attribute information, the number of passes, the number of recording patterns, the recording pattern information stored in step S1008, a code, compression method information are added to a header. In the second exemplary embodiment, information of a coding method is 1-bit information where “there is no JBIG compression processing (coding processing) (0)” if the minimum data size (DSmin) of step S907 is an initial value, and “there is JBIG compression processing (1)” if not an initial value.

If the information of a compression method is “there is no JBIG compression processing (0)”, the coded data illustrated in FIG. 13 becomes coded data generated from the code first assigned in step S1004 (initial value of coded data of step S1008). Thus, finally generated coded data never exceeds the coded data generated in step S1004 in data size.

No mask data needs to be changed, a compression rate is changed by changing the combination of the recording pattern and the code, and hence there is no need to generate a plurality of kinds of masks changed in mask pattern in order to increase a compression rate. A mask pattern change has large influence on image quality, and changing a mask pattern without causing a change in image quality is extremely difficult. Thus, no need to change any mask pattern is very advantageous for preventing an increase of manufacturing cost.

In the second exemplary embodiment, in step S1005, the coded data generated in the first exemplary embodiment is further compressed by the existing compression method. By performing the processing of steps S1007 to S1009, the codes can be assigned so that a compression rate of the existing compression method can be maximum. As a result, as compared with the first exemplary embodiment, a capacity of mask data can be reduced more.

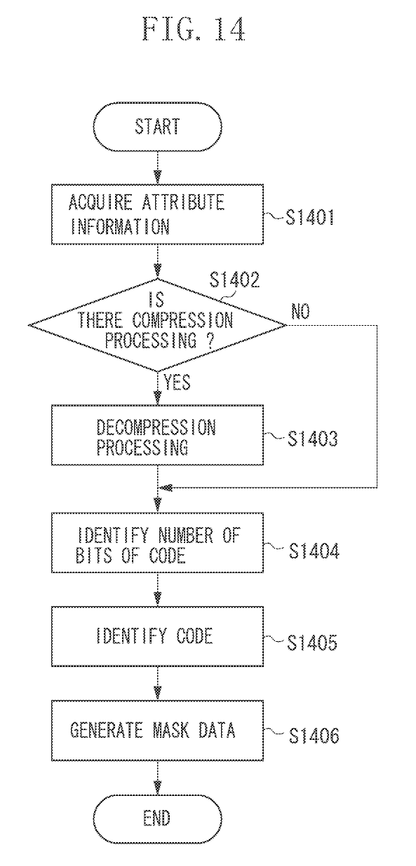

Next, referring to a flowchart of FIG. 14, the decoding processing of the mask data of the second exemplary embodiment will be described more in detail. This processing is performed by the MPU 221 of the recording apparatus 200. In the second exemplary embodiment, the processing is described in detail on the assumption that the data illustrated in FIG. 13 where the attribute data has been added to the coded data is decoded.

First, in step S1401, the MPU 221 acquires attribute information. In the second exemplary embodiment, as illustrated in FIG. 13, the attribute information containing the number of passes, the number of recording patterns, the recording pattern information, code identification information, and the compression method information is acquired.

In step S1402, the MPU 221 determines which of “there is no JBIG compression processing (0)” and “there is JBIG compression processing (1), a status is based on the compression method information acquired in step S1401. If the status is determined to be “there is JBIG compression processing (1)” (YES in step S1402), in step S1403, the MPU 221 performs decompression (decoding) processing for the compressed data to generate coded data. Subsequently, in step S1404, the MPU 221 identifies the number of bits for the code.

If the status is determined to be “there is no JBIG compression processing (0)” (NO in step S1402), without performing decoding processing of step S1403, the MPU 221 identifies the number of bits for the code. In the second exemplary embodiment, the number of bits for the code is the minimum number of bits representing the number of recording patterns. The processing of step S1404 is similar to that of the first exemplary embodiment, and thus detailed description thereof is omitted.

In step S1405, the MPU 221 identifies codes respectively assigned corresponding to the recording patterns. More specifically, the MPU 211 identifies the codes assigned to the recording patterns based on the number of recording patterns acquired in step S1401, the recording pattern information, and the code acquired in step S1401, and information of the number of bits identified in step S1404. In step S1406, the MPU 221 generates mask data from the coded data by using the number of passes and the recording information pattern acquired in step S1401, the number of bits for the code identified in step S1404, and the codes assigned to the recording patterns and identified in step S1405.

As in the case of the aforementioned coding processing, the processing will be described in detail referring to FIG. 12. The minimum number of bits for the code has been identified to be 3 bits in step S1404, and hence a pixel position 1204 (3 bits) can be identified from the coded data 1207 illustrated in FIG. 12.

A code of the pixel position 1204 is “011 (binary digit)”, and the assigning of “011” to the “recording at 4th pass” has been identified based on the recording pattern information. Thus, “1” is set as data in the pixel position 1203 of the 4th pass mask data, and “0” is set as data in the pixel positions 1200 to 1202 of the 1st to 3rd pass masks. Mask data is similarly generated in the pixel position 1205.

A code of the pixel position 1206 is “100 (binary digit)”, and the assigning of “100” to the “recording at 1st pass and 3rd pass” has been identified based on the recording pattern information. Thus, “1” is set as data in the pixel position 1100 of the 1st pass mask data and the pixel position 1202 of the 3rd pass mask data, and “0” is set as data in the pixel position 1201 of the 2nd pass mask and the data pixel position 1203 of the 4th pass mask data. By sequentially performing processing for the remaining pixel positions of the coded data 1207 through a similar procedure, mask data illustrated in FIG. 12 is generated.

According to the second exemplary embodiment, by storing a plurality of sets of coded data compressed by the compression method in the ROM 223 in FIG. 3, a memory capacity necessary for storing the masks can be reduced more greatly as compared with the first exemplary embodiment. During recording, the compressed data is read from the ROM 223, and decompressed. Then, the data is decoded by the decoding unit 227 of the ASIC to be usable as mask data.

The two exemplary embodiments have been described. However, the present invention is not limited to these exemplary embodiments. The invention can be implemented in various ways without departing from the subject matter of the invention.

The mask data of the exemplary embodiments are only examples, and sizes and values of the mask data may take other values than those illustrated therein. In the exemplary embodiments, the example for the mask data of 4 passes has been described. However, there is no limit on the number of passes within the subject matter of the present invention.

In the exemplary embodiments, the number of bits for the code is the minimum number of bits (2 bits in the first exemplary embodiment and 3 bits in the third exemplary embodiment) representing the number of recording patterns. However, in the case of mask data of N passes, any number of bits may be employed as long as it is smaller than N bits. In the exemplary embodiments, for identification of the number of bits for the code during decoding, the number of bits is calculated as the minimum number of bits representing the number of recording patterns. However, the number of bits may be identified by referring to the number of bits for the code added as attribute data.

In the first exemplary embodiment, concerning the attribute information, on the assumption that the recording apparatus knows the number of bits for the code information beforehand and has a function of analyzing the codes of the table, the attribute information needs to contain only information on the number of passes, and other pieces of information may be omitted.

In the second exemplary embodiment, the codes are assigned so that the compression rate of the compression processing (S1002) in FIG. 10 can be maximum. However, even when a compression rate is not maximum, as long as a data capacity of compressed data is smaller than that of the coded data, code assigning processing may be performed. In addition to the method for performing comparison of the data sizes (S1007) and determining the codes based on the comparison result, another method may be employed, which determines codes so that a data capacity of the compressed data can be smaller than that of the coded data.

The information (the number of passes, the number of recording patterns, and the recording pattern information) regarding the mask data and the information of the codes assigned corresponding to the recording patterns, described above in the second exemplary embodiment, may be stored beforehand as information, or determined as fixed values. Accordingly, without departing from the subject matter of the second exemplary embodiment, relevant steps in the coding processing and the decoding processing of the present exemplary embodiment or relevant information of the attribute information of FIG. 7 and FIG. 13 can be omitted.

In the second exemplary embodiment, the JBIG method has been described as the compression processing example. However, other methods may be employed as long as they are lossless compression processing. In the second exemplary embodiment, the compression processing is performed only by the JBIG method. However, one may be selected from a plurality of compression methods to perform compression.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-146931 filed Jun. 19, 2009, which is hereby incorporated by reference herein in its entirety.

What is claimed is:

1. A method for coding mask data containing information indicating, for each pixel, presence of thinning of image data in order to perform multipass recoding for a predetermined area of a recording medium by N (N: integer of 2 or more) times, the method comprising:
acquiring a plurality of mask data;
assigning a code represented by a number of bits smaller than N based on information contained in the same address of the acquired mask data and use-order of the mask data; and
generating coded data containing the assigned code corresponding to an arrangement of the address that the mask data retains information thereof.

2. The method according to claim 1, further comprising;
generating attribute data containing at least one of information regarding a number of passes and information regarding the assigned code.

3. The method according to claim 2, further comprising;
storing the attribute information and the coded data in a memory.

4. The method according to claim 2, further comprising: compressing the coded data.

5. A recording method for performing, by using a plurality of kinds of mask data containing information indicating presence of thinning of image data for each pixel, multipass recording for a predetermined area of a recording medium by N (N: integer of 2 or more) times, comprising:
reading, from a memory, coded data containing code represented by a number of bits smaller than N corresponding to an address in the mask data based on information contained in the same address of the plurality of kinds of mask data and use order of the mask data;
decoding the read coded data to the plurality of kinds of mask data by using attribute information; and
performing multipass recording by using the decoded mask data.

6. A recording apparatus for performing, by using a plurality of kinds of mask data containing information indicating presence of thinning of image data for each pixel, multipass recoding for a predetermined area of a recording medium by N (N: integer of 2 or more) times, comprising:
a first memory unit configure to store coded data containing a code represented by a number of bits smaller than N corresponding to an address in the mask data and attribute data based on information contained in the same address of the plurality of kinds of mask data and use-order of the mask data;
a decoding unit configured to decode, by using the attribute data, the coded data read from the first memory unit to the plurality of kinds of mask data;
a second memory unit configured to store the plurality of kinds of mask data decoded by the decoding unit; and
a recording unit configured to select mask data among the plurality of kinds of mask data, and to perform printing.
